(19) United States
(12) Patent Application Publication
(10) Pub. No.: US 2021/0209587 A1
(43) Pub. Date: Jul. 8, 2021

(54) Event Optimization Platform for Dynamic Identification of an Optimal Currency Combination

(71) Applicant: Bank of America Corporation, Charlotte, NC (US)

(72) Inventor: Maharaj Mukherjee, Poughkeepsie, NY (US)

(21) Appl. No.: 16/736,063

(22) Filed: Jan. 7, 2020

(51) Int. Cl. G06Q 20/38; G06Q 20/40; G06Q 20/06; G06Q 20/20; G06Q 20/36

(52) U.S. Cl. CPC G06Q 20/381; G06Q 20/405; G06Q 20/36; G06Q 20/201; G06Q 20/065

(57) ABSTRACT

Aspects of the disclosure relate to data processing systems for identifying optimal currency combinations when processing events. A computing platform may receive an event processing request and a user identifier corresponding to the event processing request. The computing platform may determine a currency profile corresponding to the user identifier and exchange rates for currencies included in the currency profile, and may execute an optimization algorithm accordingly. For example, the computing platform may identify first and second optimal solutions for processing the event processing request and may identify, by comparing the first optimal solution and the second optimal solution, that the first optimal solution is more effective. Based on the first optimal solution, the computing platform may generate a user interface indicating the currency types and amounts associated with the first optimal solution. Then, the computing platform may send the user interface to the user device for display.

### BACKGROUND

Aspects of the disclosure relate to dynamic event optimization platforms. In particular, one or more aspects of the disclosure relate to computing platforms that perform dynamic identification of optimal currency combinations for fulfilling event processing requests.

In some cases, customers of a financial institution and/or other consumers may initiate transactions and/or other events while traveling to and/or making e-commerce purchases in foreign countries. In these instances, such consumers may be required to determine a particular currency to use for making the corresponding payment. In some instances, this determination may be difficult for consumers, and the problem may be further complicated when a transaction involves one or more crypto-currencies. Thus, it may be difficult for a consumer to determine an optimal currency solution for satisfying such a payment.

### SUMMARY

Aspects of the disclosure provide effective, efficient, scalable, and convenient technical solutions that address and overcome the technical problems associated with identifying an optimal currency combination to satisfy an event processing request. For example, some aspects of the disclosure provide techniques that may enable computing devices to identify optimal currency solutions related to an event processing request based on user currency profile data and additional parameters associated with the different types of currencies included in the user currency profile. In doing so, an optimal currency solution may be determined so as to decrease time spent determining an optimal solution and to maximize currency values by intelligently conserving resources based on market trends. Accordingly, this disclosure may provide technical advantages by reducing processing power consumed in determining an optimal currency solution (e.g., by providing a computationally efficient and effective method for obtaining requisite source data and performing relevant calculations. Furthermore, the systems and methods described herein may overcome challenges associated with using currency combinations for event processing.

In accordance with one or more embodiments of the disclosure, a computing platform comprising at least one processor, a communication interface, and memory storing computer-readable instructions may receive, from a user device, an event processing request and a user identifier corresponding to the event processing request. The computing platform may determine a currency profile corresponding to the user identifier and exchange rates for one or more currencies included in the currency profile. The computing platform may execute an optimization algorithm based on the currency profile and the exchange rates. In executing the optimization algorithm, the computing platform may first identify a first optimal solution for processing the event processing request using at least a first amount of a first currency of the one or more currencies and a second amount of a second currency of the one or more currencies. Additionally, in executing the optimization algorithm, the computing platform may identify a second optimal solution for processing the event processing request using at least a third amount of the first currency of the one or more currencies and a fourth amount the second currency of the one or more currencies. Further, in executing the optimization algorithm, the computing platform may identify, by comparing the first optimal solution and the second optimal solution, that the first optimal solution may be more effective than the second optimal solution. Based on the first optimal solution, the computing platform may generate a user interface indicating the first amount of the first currency of the one or more currencies and the second amount of the second currency of the one or more currencies. In one or more instances, the user interface may present an option to fulfill the event processing request using the first optimal solution and an option to re-execute the optimization algorithm to determine a different optimal solution. Then, the computing platform may send, to the user device, the user interface, along with one or more commands directing the user device to cause display of the user interface.

In one or more instances, based on the currency profile, the computing platform may identify one or more additional parameters for input into the optimization algorithm. In response to identifying the one or more additional parameters, the computing platform may request an indication of the one or more additional parameters from a currency parameter data source system. In response to the request for the indication of the one or more additional parameters, the computing platform may receive the one or more additional parameters.

In one or more instances, the computing platform may execute the optimization algorithm based on the one or more additional parameters. In one or more instances, the one or more additional parameters may include one or more of: an exchange rate, a foreign transaction charge, a transaction speed, mining charges, trend information, or gas prices. In one or more instances, the trend information may include projected values of one or more cryptocurrencies and/or predictive information indicating whether the values will likely increase or decrease over a predetermined period of time.

In one or more instances, the computing platform may request the trend information in real time. In these instances, the request for the trend information may be sent multiple times throughout execution of the optimization algorithm. The computing platform may then receive the real time trend information.

In one or more instances, the requests for trend information may be sent at a predetermined interval. In one or more instances, the request for trend information may be sent after the first optimal solution is identified and before the second optimal solution has been identified.

In one or more instances, the computing platform may execute the optimization algorithm based on the real time trend information. In one or more instances, the first optimal solution and the second optimal solution may be determined, based at least in part, on the real time trend information.

In one or more instances, the currency profile may be an indication of one or more currency types of the one or more currencies. In one or more instances, the one or more currency types be one or more of: standard currency, foreign currency, or crypto-currency.

In one or more instances, the computing platform may receive, from the user device, an indication that the optimization algorithm should be re-executed and information identifying one or more user profile modifications. Based on the information identifying one or more user profile modifications, the computing platform may re-execute the optimization algorithm to identify a third optimal solution. In one or more instances, the information identifying the one or more user profile modifications may indicate that a particular currency type of the one or more currencies should not be used as an input to the optimization algorithm.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIGS. 1A-1B depict an illustrative computing environment for deploying an enhanced processing system that performs dynamic identification of optimal currency combinations in accordance with one or more example embodiments;

FIGS. 2A-2F depict an illustrative event sequence for deploying an enhanced processing system that performs dynamic identification of optimal currency combinations in accordance with one or more example embodiments;

FIGS. 3 and 4 depict illustrative user interfaces for deploying an enhanced processing system that performs dynamic identification of optimal currency combinations in accordance with one or more example embodiments;

FIG. 5 depicts an illustrative method for deploying an enhanced processing system that performs dynamic identification of optimal currency combinations in accordance with one or more example embodiments; and

FIG. 6 depicts an example solution space deploying an enhanced processing system that performs dynamic identification of optimal currency combinations in accordance with one or more example embodiments.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. In some instances, other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

As a brief introduction to the concepts described further herein, one or more aspects of the disclosure provide a system and method to help a customer or other user make a payment decision involving regular and crypto-currencies within the same framework. The disclosure describes, among other things, an optimization framework that may be used iteratively by a customer or other user to achieve one or more optimization criteria within a plurality of constraints.

For example, individuals and organizations often have to make a decision when traveling to foreign countries or making e-commerce purchases from other countries with regard to which currency to use for making a payment. This problem may be further complicated based on one or more of: exchange rates between currencies, foreign transaction charges charged by financial institutions, transaction amounts, whether a purchaser holds an account in multiple countries/different account types, transaction speeds for purchases that involve cash advances, or the like. This problem may be further complicated when a transaction involves crypto-currencies. For example, if a transaction is between the same crypto-currencies, an individual may consider a transaction cost (e.g., mining charges, gas prices, or the like). Additionally or alternatively, if an individual must convert from one crypto-currency to another, he or she must go through a money exchanger, which may require a transaction charge in addition to different exchange rates. Additionally or alternatively, if a transaction involves both regular and crypto-currencies, an individual must consider both the factors that may complicate a regular currency transaction and a crypto-currency transaction. Accordingly, it may be difficult for a customer to optimize the cost of the transaction and/or other charges under these and other factors. Accordingly, one or more of the systems and methods described herein provide ways of facilitating such transactions.

One or more of the systems and methods described herein address the above described deficiencies by determining a solution to a mixed linear optimization problem involving several constraints in a mixed discrete space and using an objective function. In one or more instances, the objective function may be an item such as total transaction cost including exchange rates, transaction charges, mining charges, gas prices, transaction speed, or the like. Constraints on the discrete space may be defined based on an amount of each currency that is available, transaction speed, transaction amount allowed by applicable regulation(s) and local jurisdiction, or the like. In one or more instances, once a discrete space is characterized in terms of constraints and an optimization factor, a computing platform may identify a solution using methods such as a Greedy algorithm, simulated annealing method, or the like. After determining the solution, the computing platform may present the solution (including total cost, transaction speed, or the like) to a customer for final approval. If the customer is happy with the solution, he or she may confirm the solution and request that the transaction be executed. In some instances, further authorization may be obtained, tax payments may be made, or the like. In other instances, a customer may be dissatisfied with the solution and may request either a reduction in transaction time or cost. In these instances, the computing platform may generate and present a new solution. In yet additional instances, if the computing platform is unable to determine a solution, the customer may either roll back to a previously determined solution or select different optimization criteria.

Accordingly, by performing one or more of the methods described herein, the computing platform may assist a customer with payment decisions involving regular and crypto-currencies within a common framework, and may provide an optimization framework that may be used iteratively by customers to achieve one or more optimization criteria within a plurality of constraints.

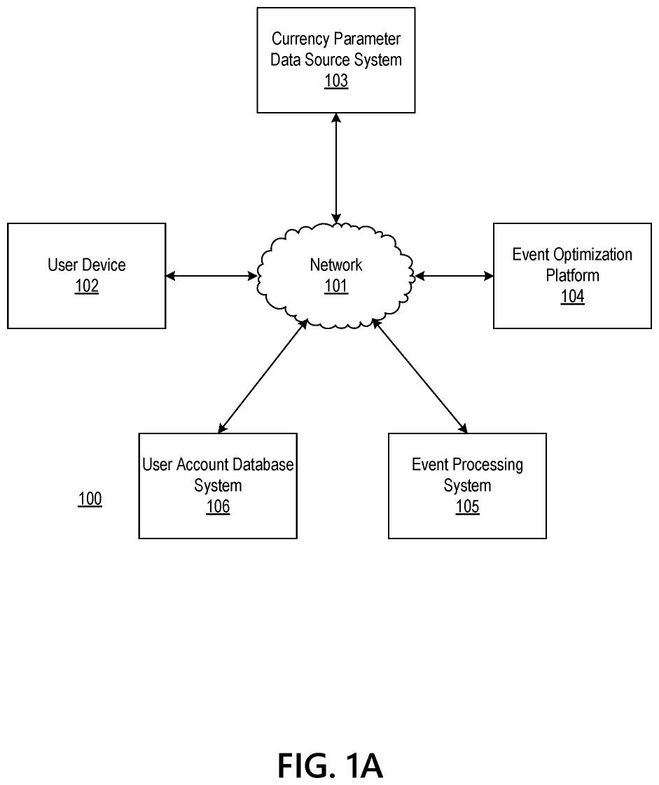

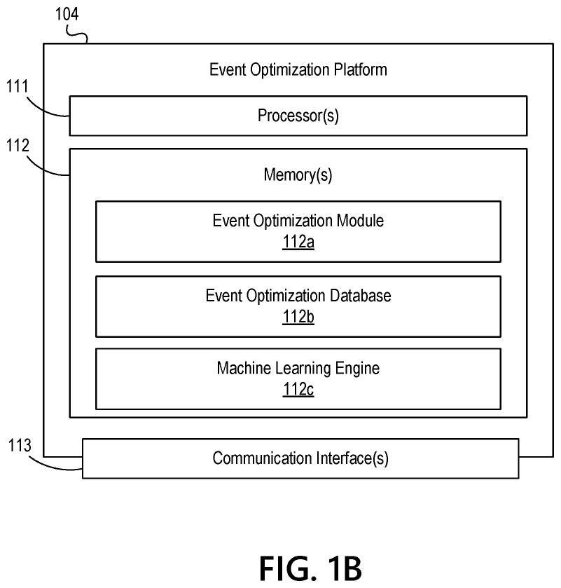

FIGS. 1A-1B depict an illustrative computing environment for deploying an enhanced processing system that performs dynamic identification of optimal currency combinations in accordance with one or more example embodiments. Referring to FIG. 1A, computing environment 100 may include one or more computer systems. For example, computing environment 100 may include user device 102, currency parameter data source system 103, event optimization platform 104, event processing system 105, and user account database system 106.

User device 102 may be a desktop computer, laptop computer, tablet, mobile device, or the like, and may be used to send requests for event processing. In addition, user device 102 may cause display of and/or otherwise present one or more graphical user interfaces (e.g., solution interfaces including proposed currency combinations for processing a requested event, modification interfaces prompting for information identifying user profile modifications, or the like). In one or more instances, the user device 102 may be configured to receive user input, request solution interface information, and request profile modifications and/or event processing in response to the solution interface information.

Currency parameter data source system 103 may be a computer system that includes one or more computing devices (e.g., servers, server blades, or the like) and/or other computer components (e.g., processors, memories, communication interfaces). In one or more instances, currency parameter data source system 103 may be configured to receive and respond to queries requesting one or more data values corresponding to one or more currency parameters. In these instances, the currency parameter data source system 103 may maintain a database correlating various currencies to one or more currency parameters (e.g., exchange rates, foreign transaction charges, transaction speed, mining charges, gas prices, or the like) and may be configured to perform lookup functions or the like based on an identified currency to determine one or more parameters corresponding to the identified currency.

As described further below, event optimization platform 104 may be a computer system that includes one or more computing devices (e.g., servers, server blades, or the like) and/or other computer components (e.g., processors, memories, communication interfaces) that may be used to execute one or more event optimization algorithms (e.g., perform a simulated annealing algorithm) to identify a currency solution (e.g., a currency combination to satisfy a particular payment, or the like). In one or more instances, the event optimization platform 104 may also be configured to dynamically adjust to changing parameters and user preferences by maintaining one or more machine learning datasets. In some instances, the event optimization platform 104 may be maintained by an organization such as a financial institution, and may be configured to receive requests from one or more user devices, which may each be linked to and/or otherwise associated with a customer of the financial institution.

Event processing system 105 may be a computer system that includes one or more computing devices (e.g., servers, server blades, or the like) and/or other computer components (e.g., processors, memories, communication interfaces) that may be used to process events in response to commands received from a user device (e.g., user device 102, or the like). In one or more instances, the event processing system 105 may be affiliated with the same organization that maintains the event optimization platform 104. In other instances, the event processing system 105 may be affiliated with a different organization than the one that maintains the event optimization platform 104. In one or more instances, the event processing system 105 may be configured to conduct a transaction by transferring one or more currencies of equal or varied quantities from a first user and/or organization's accounts and into a second user and/or organization's accounts.

User account database system 106 may be a computer system that includes one or more computing devices (e.g., servers, server blades, or the like) and/or other computer components (e.g., processors, memories, communication interfaces) that may be used to maintain account balances corresponding to various currencies held by a particular user and/or organization. Accordingly, in response to receiving a request for a user profile comprising the types and quantities of currencies held by a particular user and/or organization, the user account database system 106 may be configured to perform a lookup function to identify a quantity of each currency associated with the particular user and/or organization, and to send an indication of these currency quantities to the event optimization platform 104 and/or other computing systems.

Computing environment 100 also may include one or more networks, which may interconnect user device 102, currency parameter data source system 103, event optimization platform 104, event processing system 105, and user account database system 106. For example, computing environment 100 may include a network 101 (which may interconnect, e.g., user device 102, currency parameter data source system 103, event optimization platform 104, event processing system 105, and user account database system 106).

In one or more arrangements, user device 102, currency parameter data source system 103, event optimization platform 104, event processing system 105, and user account database system 106 may be any type of computing device capable of sending and/or receiving requests and processing the requests accordingly. For example, user device 102, currency parameter data source system 103, event optimization platform 104, event processing system 105, user account database system 106 and/or the other systems included in computing environment 100 may, in some instances, be and/or include server computers, desktop computers, laptop computers, tablet computers, smart phones, or the like that may include one or more processors, memories, communication interfaces, storage devices, and/or other components. As noted above, and as illustrated in greater detail below, any and/or all of user device 102, currency parameter data source system 103, event optimization platform 104, event processing system 105, and user account database system 106 may, in some instances, be special-purpose computing devices configured to perform specific functions.

Referring to FIG. 1B, event optimization platform 104 may include one or more processors 111, memory 112, and communication interface 113. A data bus may interconnect processor 111, memory 112, and communication interface 113. Communication interface 113 may be a network interface configured to support communication between event optimization platform 104 and one or more networks (e.g., network 101, or the like). Memory 112 may include one or more program modules having instructions that when executed by processor 111 cause event optimization platform 104 to perform one or more functions described herein and/or one or more databases that may store and/or otherwise maintain information which may be used by such program modules and/or processor 111. In some instances, the one or more program modules and/or databases may be stored by and/or maintained in different memory units of event optimization platform 104 and/or by different computing devices that may form and/or otherwise make up event optimization platform 104. For example, memory 112 may have, host, store, and/or include an event optimization module 112a, an event optimization database 112b, and a machine learning engine 112c.

Event optimization module 112a may have instructions that direct and/or cause event optimization platform 104 to execute advanced techniques for dynamically identifying an optimal currency combination for event processing, as discussed in greater detail below. Event optimization database 112b may store information used by event optimization module 112a and/or event optimization platform 104 in identifying optimal currency combinations for event processing and/or in performing other functions. Machine learning engine 112c may have instructions that direct and/or cause the event optimization platform 104 to perform event management and to set, define, and/or iteratively refine optimization rules and/or other parameters used by the event optimization platform 104 and/or other systems in computing environment 100.

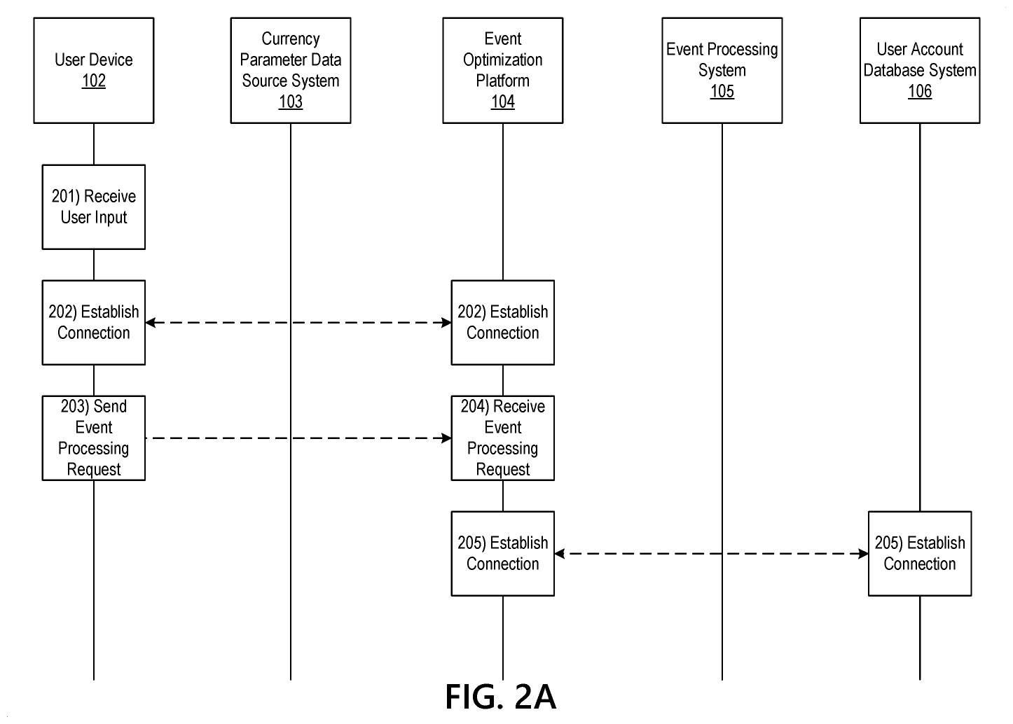

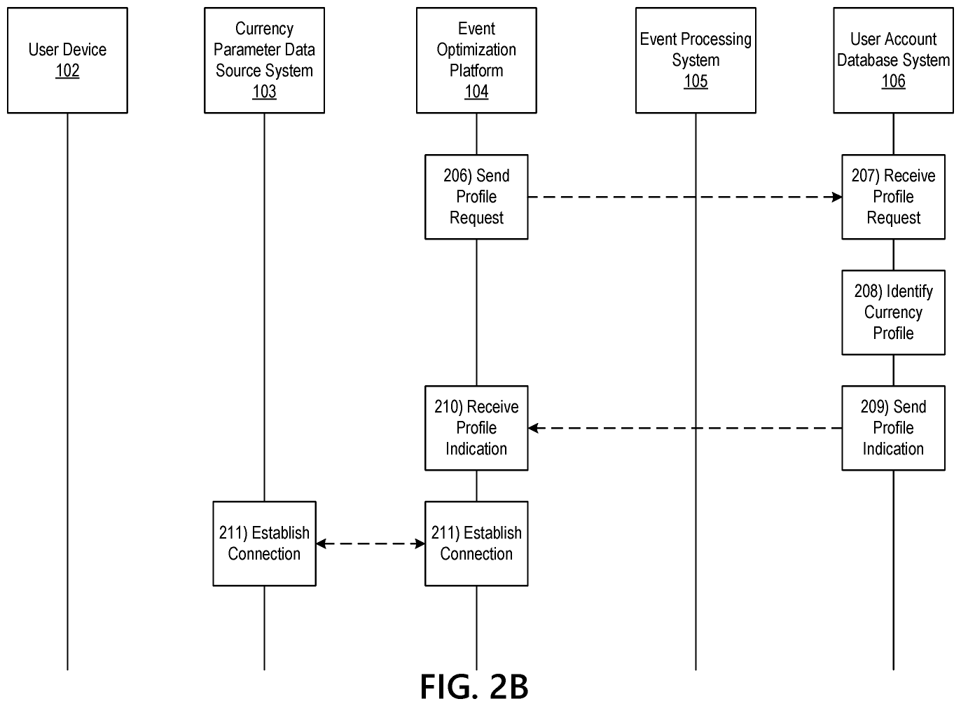

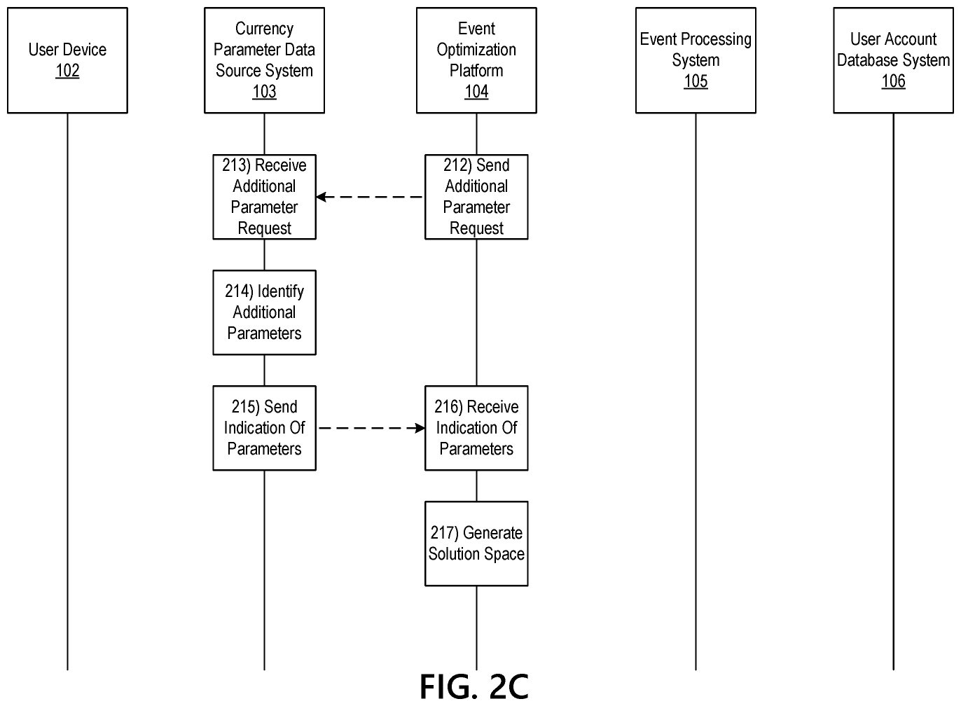

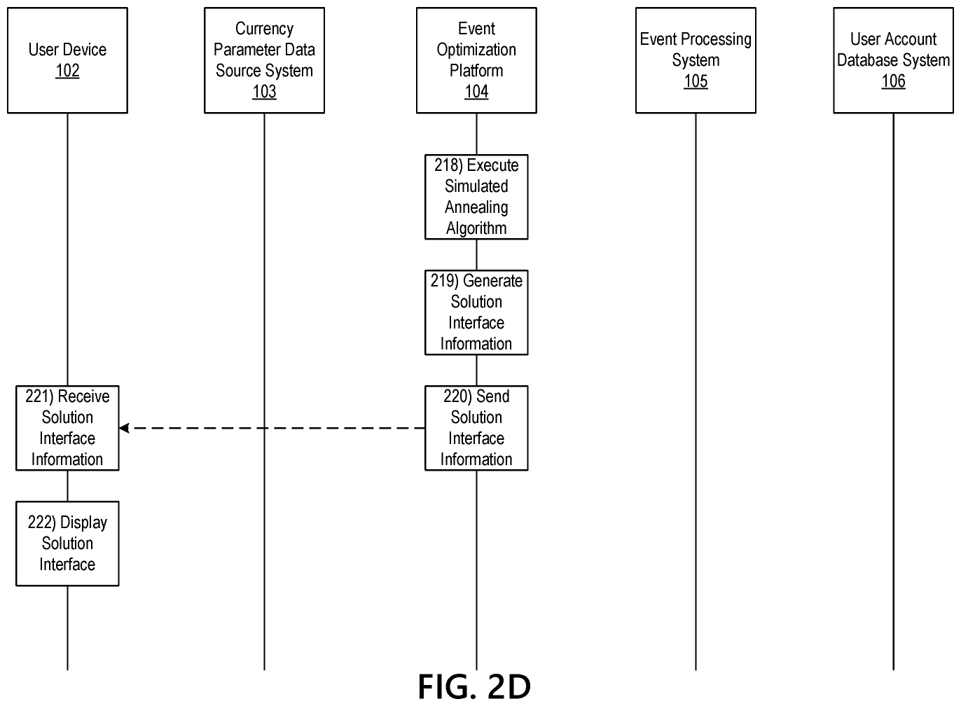

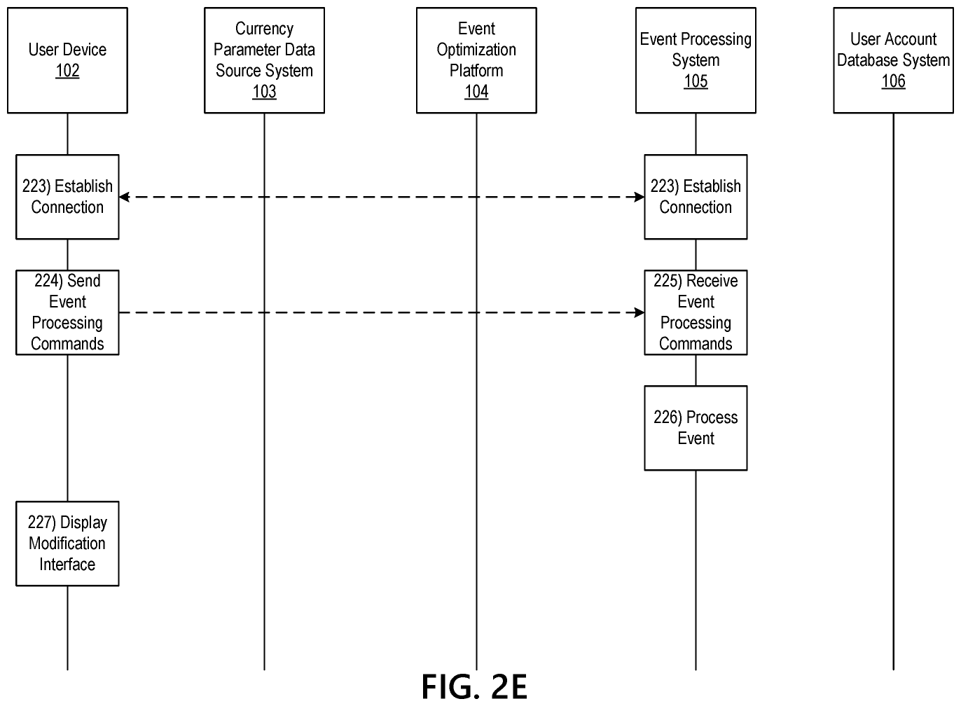

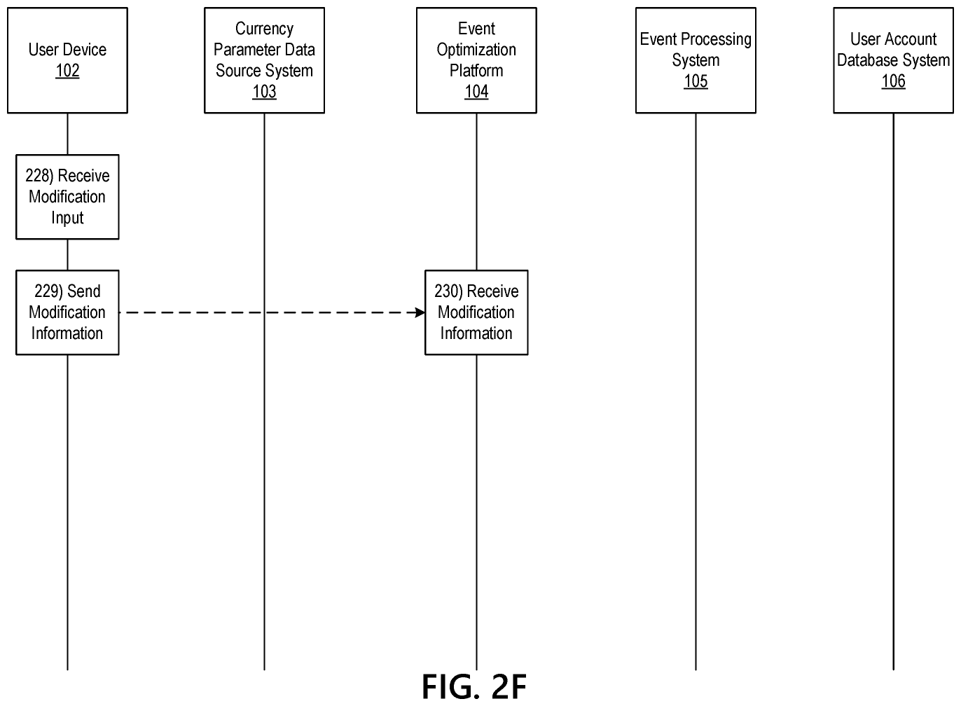

FIGS. 2A-2F depict an illustrative event sequence for deploying an enhanced processing system that performs dynamic identification of optimal currency combinations in accordance with one or more example embodiments. Referring to FIG. 2A, at step 201, the user device 102 may receive user input indicating a particular event for processing. For example, in receiving the user input, the user device 102 may receive a request for a transaction or purchase to be completed on behalf of a user or organization affiliated with the user device 102. In one or more instances, in receiving the user input, the user device 102 may receive input through an online shopping vendor, a service provider, or the like, which may be displayed via a display of the user device 102. Additionally, in receiving the user input, the user device 102 may receive an indication of a price associated with the event for processing (which may, in some instances, be specified in a particular currency).

At step 202, the user device 102 may establish a connection with the event optimization platform 104. In one or more instances, the user device 102 may establish a first wireless data connection with the event optimization platform 104 to link the user device 102 with the event optimization platform 104. In some instances, the user device 102 may determine whether a connection was previously established with the event optimization platform 104. If the user device 102 determines that a connection was previously established with the event optimization platform 104, the user device 102 might not attempt to re-establish the connection. If the user device 102 determines that a connection was not previously established, the user device 102 may establish the connection as described herein.

At step 203, the user device 102 may send, share, or otherwise provide an event processing request to the event optimization platform 104. In one or more instances, the user device 102 may send the event processing request to the event optimization platform 104 in response to receiving the user input at step 201. In one or more instances, the user device 102 may send the event processing request to the event optimization platform 104 while the first wireless data connection is established.

At step 204, the event optimization platform 104 may receive or otherwise access the event processing request sent at step 203. In one or more instances, the event optimization platform 104 may receive the event optimization request via the communication interface 113 and while the first wireless data connection is established. In one more instances, in receiving the event processing request, the event optimization platform 104 may receive an indication of a price, a payor, and a payee associated with the event.

At step 205, the event optimization platform 104 may establish a connection with user account database system 106. In one or more instances, the event optimization platform 104 may determine whether a connection has already been established with the user account database system 106. If the event optimization platform 104 determines that a connection has already been established with the user account database system 106, the event optimization platform 104 might not attempt to re-establish the connection. If the event optimization platform 104 determines that a connection has not been established with the user account database system 106, the event optimization platform 104 may establish the connection as described herein. In one or more instances, in establishing the connection with the user account database system 106, the event optimization platform 104 may establish a second wireless data connection with the user account database system 106 to link the event optimization platform 104 to the user account database system 106.

Referring to FIG. 2B, at step 206, event optimization platform 104 may determine a payor (e.g., the individual making the event processing request) associated with the event processing request. In one or more instances, the event optimization platform 104 may receive or otherwise access, along with the event processing request, a token, user identifier, or the like, that identifies the payor. After identifying the payor, the event optimization platform 104 may send, share, or otherwise provide a request, to the user account database system 106, for a user currency profile (e.g., a list of currency types and quantities of each type held by the payor) associated with the identified payor. In one or more instances, the event optimization platform 104 may send a user identifier, token, or the like along with the request for the user currency profile. In one or more instances, the event optimization platform 104 may send the request for the user currency profile and/or the user identifier via the communication interface 113 and while the second wireless data connection is established.

At step 207, the user account database system 106 may receive or otherwise access the request for the user currency profile sent at step 206. In one or more instances, the user account database system 106 may receive the request for the user currency profile while the second wireless data connection is established. As described above at step 206, in one or more instances, in receiving the request for the user currency profile, the user account database system 106 may receive a user identifier, token, or the like, that may be used by the user account database system 106 to identify the payor.

At step 208, in response to receiving the request for the user currency profile, the user account database system 106 may identify the requested user currency profile. For example, in one or more instances, the user account database system 106 may perform a lookup function based on a user identifier, token, or the like that identifies the payor. In these instances, the user account database system 106 may determine a currency, and an associated quantity of the currency, available in an account associated with the payor. The user account database system 106 may then continue to identify additional currencies and their associated quantities until a type and quantity of each currency present in the payor's accounts have been identified. As an example, the user account database system 106 may determine that “Payor 1” is the payor, and that “Payor 1” has 100,000 of currency #1, 500,000 of currency #2, and 75,000 of currency #3 available for use in processing the event requested at step 203.

At step 209, the user account database system 106 may generate an indication of the user currency profile identified at step 208. In these instances, the user account database system 106 may send, share, or otherwise provide the indication of the user currency profile to the event optimization platform 104. In one or more instances, the user account database system 106 may send the indication of the user currency profile to the event optimization platform 104 while the second wireless data connection is still established.

At step 210, the event optimization platform 104 may receive or otherwise access the indication of the user currency profile sent at step 209. In these instances, the event optimization platform 104 may receive the indication of the user currency profile via the communication interface 113 and while the second wireless data connection is established. Accordingly, based on the indication of the user currency profile, the event optimization platform 104 may determine a virtual wallet for the user that may include various types of currency held by the user and the associated quantities of these types of currency. For example, based on the indication of the user currency profile, the event optimization platform 104 may determine that the user has a first amount of currency x, a second amount of currency y, and a third amount of currency z. In one or more instances, the event optimization platform 104 may determine that the virtual wallet contains a combination of standard, foreign, and crypto-currencies.

At step 211, the event optimization platform 104 may establish a connection with the currency parameter data source system 103. In one or more instances, in establishing the connection with the currency parameter data source system 103, the event optimization platform 104 may establish a third wireless data connection with the currency parameter data source system 103 to link the event optimization platform 104 with the currency parameter data source system 103. In one or more instances, the event optimization platform 104 may determine whether a connection has already been established with the currency parameter data source system 103. If the event optimization platform 104 determines that a connection has already been established, the event optimization platform 104 might not attempt to reestablish the connection. If the event optimization platform 104 determines that the connection has not yet been established, the event optimization platform 104 may attempt to establish the connection as described herein.

Referring to FIG. 2C, at step 212, the event optimization platform 104 may generate and send, share, or otherwise provide a request for one or more additional parameters corresponding to one or more currencies identified in the user currency profile. In one or more instances, before sending the request for the additional parameters, the event optimization platform 104 may identify what additional parameters should be requested based on the currency types identified in the user currency profile. For example, in some instances, the user currency profile may identify one or more crypto-currencies that may be used to process the event. In these instances, the event optimization platform 104 may determine that certain additional parameters such as mining charges, gas prices, crypto exchange rates, transaction charges, or the like should be determined. In other instances, the event optimization platform 104 may determine that the user currency profile does not include any crypto-currencies, and thus the parameters described above might not need to be determined. In these instances, however the event optimization platform 104 may determine that the user currency profile includes various standard currencies, and thus the event optimization platform 104 may determine that additional parameters such as exchange rates, foreign transaction charges, transaction speed, or the like should be determined. After identifying the various additional parameters that should be determined, the event optimization platform 104 may generate the request for the one or more additional parameters corresponding to one or more currencies identified in the user currency profile and may send the request for the one or more additional parameters to the currency parameter data source system 103. In one or more instances, the event optimization platform 104 may send the additional parameter request to the currency parameter data source system 103 via the communication interface 113 and while the third wireless data connection is established.

In one or more instances, the event optimization platform 104 may send requests for additional parameters (e.g., trend information, or the like) in real time while executing a simulated annealing algorithm. In these instances, steps 212-217 may be continually performed while the event optimization platform 104 executes the simulated annealing algorithm at step 218. Additionally or alternatively, the requests for the additional parameters may be sent at a predetermined interval, which may be automatically determined by the event optimization platform 104 or determined based on user input.

At step 213, the currency parameter data source system 103 may receive or otherwise access the request for the one or more additional parameters sent at step 212. In one or more instances, the currency parameter data source system 103 may receive the request for the one or more additional parameters while the third wireless data connection is established. In one or more instances, in receiving the request for the one or more additional parameters, the currency parameter data source system 103 may receive indications of specific parameters for which to determine values. Additionally or alternatively, in receiving the request for the one or more additional parameters, the currency parameter data source system 103 may receive indications of the currency types in the indication of the user currency profile, received by the event optimization platform 104 at step 210. In these instances, the currency parameter data source system 103 may perform a lookup function based on the currency types identified to determine corresponding parameters. For example, if the currency parameter data source system 103 determines that the currency types do not include a crypto-currency, the currency parameter data source system 103 might not investigate mining charges associated with the various currency types (e.g., by querying one or more remote data sources that maintain such information). However, if the currency parameter data source system 103 determines that the currency types include a foreign currency, the currency parameter data source system 103 may investigate exchange rates associated with that foreign currency.

At step 214, the currency parameter data source system 103 may identify the one or more additional parameters. For example, the currency parameter data source system 103 may determine mining charges, gas prices, transaction charges, exchange rates, transaction speeds, transaction limits, trend data or the like corresponding to the one or more additional parameters and/or the identified currency types.

At step 215, after identifying the additional parameters at step 214, the currency parameter data source system 103 may send, share, or otherwise provide an indication of the additional parameters to the event optimization platform 104. For example, in sending the indication of the additional parameters, the currency parameter data source system 103 may send source data comprising mining charges, gas prices, transaction charges, exchange rates, transaction speeds (e.g., today is a holiday in the country of currency x so the transaction time may be longer by a specific amount of time if currency x is used than if currency y is used, or the like), transaction limits (e.g., limits on quantities of foreign, standard, and/or crypto-currencies sent in a single transaction, or the like), trend data (e.g., curves showing changing values of a particular crypto-currency, or the like) or the like corresponding to the one or more additional parameters and/or the identified currency types. In one or more instances, the currency parameter data source system 103 may send the indication of the additional parameters to the event optimization platform 104 while the third wireless data connection is established.

At step 216, event optimization platform 104 may receive or otherwise access the indication of the additional parameters sent at step 215. In one or more instances, the event optimization platform 104 may receive the indication of the additional parameters via the communication interface 113 and while the third wireless data connection is established.

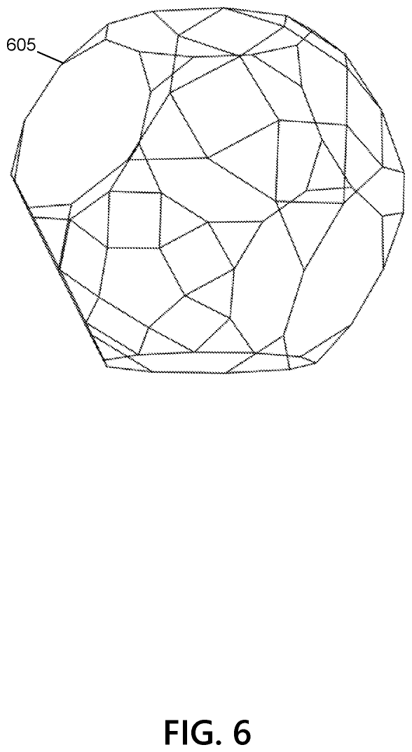

At step 217, the event optimization platform 104 may generate a solution space based on the currency types in the user currency profile and the indication of the additional parameters received at step 216. In one or more instances, in defining the solution space, the event optimization platform 104 may create a virtual space similar to solution space 605, which is shown in FIG. 6. For example, each point of the outer boundary of solution space 605 may be defined based on a particular constraint (e.g., the additional parameters, the currency types, the currency amounts, transaction amount, or the like). For example, the x-axis may represent a value of a currency combination, the y-axis may represent a quantity of each currency in the combination, and the z-axis may represent additional constraints (additional charges/costs, or the like) associated with the combination. Additionally or alternatively, each axis may represent a different currency type. In these instances, each point in the solution space may represent a currency combination that has a value equivalent to the value of the event requested for processing at step 201. As a further illustration, a particular point in the middle of the solution space 605 may represent a first amount of a first currency, a second amount of a second currency, and a third amount of a third currency. It should be understood that although solution space 605 is graphically represented in FIG. 6, event optimization platform 104 may, in some instances, generate a solution space based on various constraints that may be graphically represented in a different format or not graphically represented at all.

Referring to FIG. 2D, at step 218, the event optimization platform 104 may execute a simulated annealing algorithm based on the solution space generated at step 217. In one or more instances, in executing the simulated annealing algorithm, the event optimization platform 104 may randomly select a first optimal solution within the solution space. In these instances, the event optimization platform 104 may then randomly select a second optimal solution within the solution space, and may compare a probability that the second optimal solution is the better solution to a probability that the first optimal solution is the better solution. Depending on which of the probabilities is higher, the event optimization platform 104 may select the corresponding optimal solution. In these instances, the corresponding optimal solution may become the new first optimal solution.

In some instances (e.g., when selecting the first optimal solution within the solution space and/or otherwise when initiating execution of the simulated annealing algorithm), the event optimization platform 104 may define an initial temperature. In some instances, the event optimization platform 104 may automatically determine the initial temperature. In other instances, the event optimization platform 104 may receive user input indicating the initial temperature. As time progresses, the event optimization platform 104 may decrease the temperature (e.g., based on a cooling rate determined automatically or by user input), and in doing so, the event optimization platform 104 may progressively identify solutions that are closer and closer to the optimal solution value. In these instances, the event optimization platform 104 may dynamically adjust the cooling rate using machine learning algorithms to determine a most effective cooling rate. As the event optimization platform 104 cools the temperature, it may determine potential solutions within the solution space that are closer and closer to each other (e.g., the event optimization platform 104 may perform smaller and smaller jumps progressively when evaluating other potential solutions within the solution space as temperature is cooled). For example, as the event optimization platform 104 cools the temperature, solutions may begin to converge and may be closer to each other (in proximity within the solution space) than solutions determined at higher temperatures. In one or more instances, a convergence time may be automatically determined by the event optimization platform 104. In other instances, the convergence time may be specified by a user input. Once the event optimization platform 104 determines that the temperature has reach zero, the event optimization platform 104 may identify a final optimal solution. As an example, in determining the final optimal solution, the event optimization platform 104 may perform a final determination that a combination of a first amount of currency x, a second amount of currency y, and a third amount of currency z, is the optimal method of payment for a particular transaction, and should be used to process the event requested at step 201. In this example, the coordinates of the final optimal solution in the solution space may indicate the first amount of currency x, the second amount of currency y, and the third amount of currency z.

At step 219, once the final optimal solution has been determined, the event optimization platform 104 may generate solution interface information. In one or more instances, in generating the solution interface information, the event optimization platform 104 may generate information that may be used to generate a user interface that may include information identifying the final optimal solution.

At step 220, the event optimization platform 104 may send, share, or otherwise provide the solution interface information to the user device 102. In one or more instances, the event optimization platform 104 may send the solution interface information to the user device 102 via the communication interface 113 and while the first wireless data connection is established. In one or more instances, along with the solution interface information, the event optimization platform 104 may send, share, or otherwise provide one or more commands directing the user device 102 to generate and display a graphical interface using the solution interface information.

At step 221, the user device 102 may receive or otherwise access the solution interface information sent at step 220. In one or more instances, the user device 102 may receive the solution interface information from the event optimization platform 104 while the first wireless data connection is established.

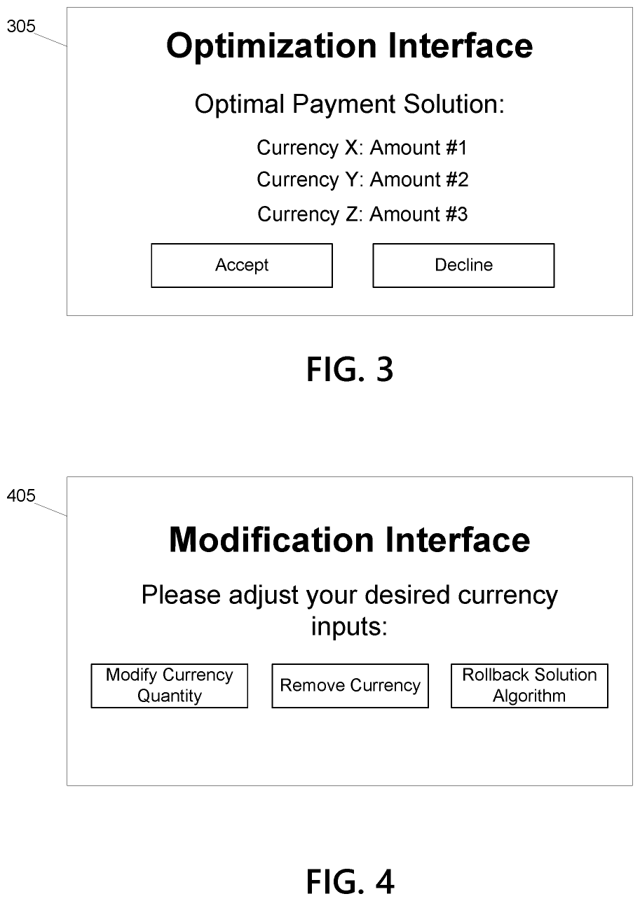

At step 222, the user device 102 may generate and display a solution interface based on the solution interface information received at step 221. In one or more other instances, the user device 102 might not generate the solution interface, but rather may receive the solution interface from the event optimization platform 104 and may simply cause display of the solution interface. In causing display of the solution interface, the user device 102 may display a user interface similar to graphical user interface 305, which is shown in FIG. 3. For example, graphical user interface 305 may be an optimization interface configured to present an optimal payment solution (e.g., the final optimal solution determined at step 218 by the event optimization platform 104) to a user. In doing so, the graphical user interface 305 may display a proposed currency combination for making a payment corresponding to the event processing request. For example, the graphical user interface 305 may indicate that a first amount of currency x, a second amount of currency y, and a third amount of currency z has been determined to be the most optimal payment solution. In addition, graphical user interface 305 may present options for the user to accept or to decline the proposed solution. If the user device 102 receives user input indicating that the proposed solution was accepted, the user device 102 may proceed to step 223. If, however, the user device 102 receives user input indicating that the proposed solution was declined, the user device 102 may proceed to step 227.

Referring to FIG. 2E, at step 223, the user device 102 may establish a connection with the event processing system 105. In one or more instances, the user device 102 may establish a fourth wireless data connection with the event processing system 105 to link the user device 102 to the event processing system 105. In one or more instances, the user device 102 may determine whether a connection was already established with the event processing system 105. If the user device 102 determines that a connection was already established with the event processing system 105, the user device 102 might not attempt to re-establish the connection. However, if the user device 102 determines that a connection was not established with the event processing system 105, the user device 102 may proceed as described herein to establish the connection.

At step 224, the user device 102 may generate and send, share, or otherwise provide one or more commands directing the event processing system 105 to process the event (as requested at step 201) using the currency combination presented via the solution interface at step 222. In one or more instances, the user device 102 may generate and send the one or more commands directing the event processing system 105 to process the event using the currency combination presented via the solution interface at step 222 based on a received user input indicating that the user selected “Accept” from the graphical user interface 305 that was displayed at step 222. In these instances, the user device 102 may send the one or more commands directing the event processing system 105 to process the event while the fourth wireless data connection is established.

At step 225, the event processing system 105 may receive or otherwise access the one or more commands, sent at step 224, directing the event processing system 105 to process the event using the currency combination presented via the solution interface. In these instances, the user device 102 may receive the one or more commands directing the event processing system 105 to process the event via the communication interface 113 and while the fourth wireless data connection is established.

At step 226, in response to the one or more commands directing the event processing system 105 to process the event using the currency combination presented via the solution interface, the event processing system 105 may process the event (requested at step 201) using the currency combination approved by the user at step 222. For example, the event processing system 105 may cause the approved quantities of the indicated currency types to be transferred from one or more accounts associated with the user (e.g., the payor) to one or more accounts associated with the target payee (e.g., by updating one or more account records maintained by the event processing system 105 and/or one or more other back-office computer systems). Subsequently, the event sequence may end unless the user wishes to send additional event processing requests, in which case the event sequence may return to step 201.

At step 227, the user device 102 may display a modification interface. In causing display of the modification interface, the user device 102 may cause display of a graphical user interface similar to graphical user interface 405, which is shown in FIG. 4. For example, the modification interface may provide one or more options for the user to have a new solution determined. In one or more instances, the user device 102 may display the modification interface in response to receiving user input indicating that a user selected “Decline” via the graphical user interface 305. In some instances, the user may want to modify a quantity of a particular currency that is available (e.g., wants to keep 50% of a currency x in savings, or the like). In these instances, the user may select “Modify Currency Quantity.” Additionally or alternatively, the user may want to remove a particular currency from the solution space entirely (e.g., may want to save a particular crypto-currency due to anticipated increases in value, or the like). In these instances, the user may select “Remove Currency.” Additionally or alternatively, the user may want to maintain the same inputs to the simulated annealing algorithm, but may simply want to see an alternative solution. In these instances, the user may select “Rollback Solution Algorithm,” and the event optimization platform 104 may rollback to a second to last optimal solution determined.

Referring to FIG. 2F, at step 228, the user device 102 may receive or otherwise access a modification input. For example, the user device 102 may receive an input from the user indicating modifications to the solution space and/or requesting a rollback to the presented solution (e.g., the inputs described above with regard to graphical user interface 405 at step 227).

At step 229, the user device 102 may generate and send, share, or otherwise provide modification information to the event optimization platform 104. In one or more instances, the user device 102 may generate and send information corresponding to changes to the solution space, rollbacks, or the like requested by the user at step 228. In one or more instances, in sending the modification information to the event optimization platform 104, the user device 102 may send the modification information to the event optimization platform 104 while the first wireless data connection is established.

At step 230, the event optimization platform 104 may receive or otherwise access the modification information sent at step 229. In these instances, the event optimization platform 104 may receive the modification information via the communication interface 113 and while the first wireless data connection is still established. After receiving the modification information, the event optimization platform 104 may update one or more stored machine learning datasets used to determine one or more updated solutions based on the modification information. In some instances, in response to receiving the modification information, the event optimization platform 104 may redefine the solution space based on the modification information, and may return to step 217 (and, e.g., repeat performance of the subsequent steps to iteratively determine an updated solution). In other instances, the event optimization platform 104 may perform a further iteration and/or a rollback to a previously determined solution. In these instances, the event optimization platform 104 may return to step 218.

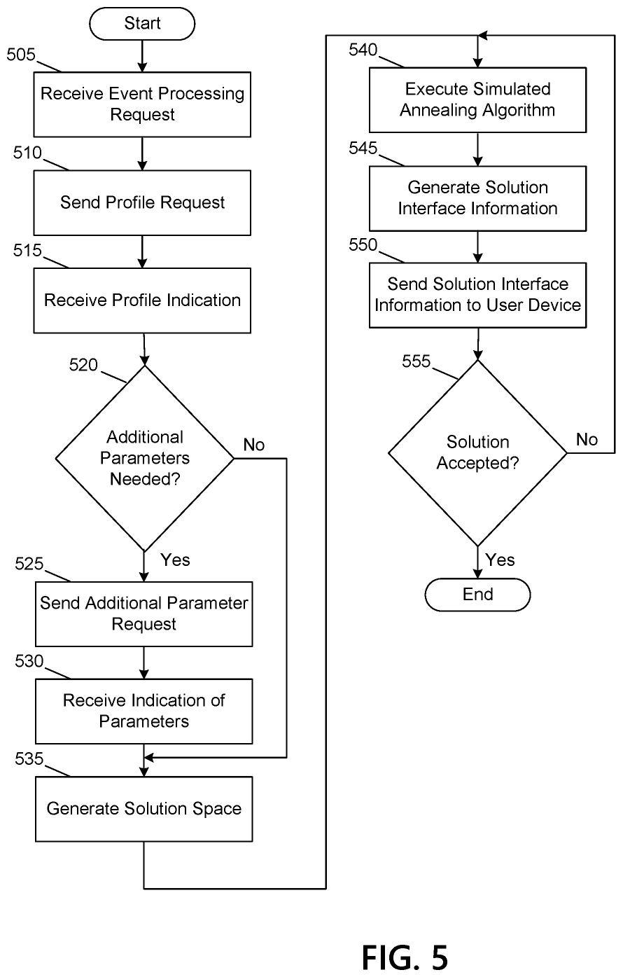

FIG. 5 depicts an illustrative method for identification of an optimal currency combination for event processing in accordance with one or more example embodiments. Referring to FIG. 5, at step 505, a computing platform having at least one processor, a communication interface, and memory may receive an event processing request from a user device. At step 510, the computing platform may send a request for a user currency profile and a user identifier to a user account database system 106. At step 515, the computing platform may receive a profile indication indicating the user currency profile associated with the user identifier. At step 520, the computing platform may determine whether any additional parameters associated with the user currency profile are needed. If the computing platform determines that additional parameters are not needed, the computing platform may proceed to step 535. If the computing platform determines that additional parameters are needed, the computing platform may proceed to step 525.

At step 525, the computing platform may send an additional parameter request to a currency parameter data source system. At step 530, in response to the additional parameter request, the computing platform may receive an indication of the additional parameters. At step 535, the computing platform may generate a solution space based on the user currency profile, the event processing request, and any additional parameters. At step 540, the computing platform may execute a simulated annealing algorithm to determine a proposed currency combination for fulfilling the event processing request. At step 545, the computing platform may generate solution interface information based on the proposed currency combination. At step 550, the computing platform may send the solution interface information to the user device. At step 555, the computing platform may determine whether the proposed currency combination was accepted by a user of the user device. If the proposed currency combination was not accepted, the computing platform may return to step 540 (e.g., to re-execute the simulated annealing algorithm to determine a new proposed currency combination for fulfilling the event processing request). If the proposed currency combination was accepted, the method may end. Accordingly, the event processing request may be conducted in a manner that resolves one or more technical problems associated with conducted transactions using a plurality of available currencies. For example, by determining an optimal currency combination (including standard, foreign, and crypto-currencies) for fulfilling an event processing request, transactions may be efficiently processed and currency values of a user's accounts and/or portfolios may be maximized. Accordingly, this may reduce time spent manually identifying an optimal payment solution based on available currencies and additional parameters, and further may maximize account values by conserving certain currency types and using others to conduct transactions based on whichever offers the most effective solution under given constraints. Accordingly, the systems and methods described herein may provide technical advantages by reducing processing power consumed in determining an optimal currency solution (e.g., by providing a computationally efficient and effective method for obtaining requisite source data and performing relevant calculations.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

What is claimed is:

1. A computing platform comprising:
at least one processor;
a communication interface communicatively coupled to the at least one processor; and
memory storing computer-readable instructions that, when executed by the at least one processor, cause the computing platform to:
receive, from a user device, an event processing request and a user identifier corresponding to the event processing request;
determine a currency profile corresponding to the user identifier and exchange rates for one or more currencies included in the currency profile;
execute an optimization algorithm based on the currency profile and the exchange rates, wherein executing the optimization algorithm comprises:
identifying a first optimal solution for processing the event processing request using at least a first amount of a first currency of the one or more currencies and a second amount of a second currency of the one or more currencies;
identifying a second optimal solution for processing the event processing request using at least a third amount of the first currency of the one or more currencies and a fourth amount the second currency of the one or more currencies;
identify, by comparing the first optimal solution and the second optimal solution, that the first optimal solution is more effective than the second optimal solution;
generate, based on the first optimal solution, a user interface indicating the first amount of the first currency of the one or more currencies and the second amount of the second currency of the one or more currencies, wherein the user interface presents an option to fulfill the event processing request using the first optimal solution and an option to re-execute the optimization algorithm to determine a different optimal solution; and
send, to the user device, the user interface, along with one or more commands directing the user device to cause display of the user interface.

2. The computing platform of claim 1, wherein the memory stores additional computer-readable instructions that, when executed by the at least one processor, further cause the computing platform to:
identify, based on the currency profile, one or more additional parameters for input into the optimization algorithm;
request, in response to identifying the one or more additional parameters, an indication of the one or more additional parameters from a currency parameter data source system; and
receive, in response to the request for the indication of the one or more additional parameters, the one or more additional parameters.

3. The computing platform of claim 2, wherein executing the optimization algorithm further comprises executing, based on the one or more additional parameters, the optimization algorithm.

4. The computing platform of claim 2, wherein the one or more additional parameters comprise one or more of: an exchange rate, a foreign transaction charge, a transaction speed, mining charges, trend information, or gas prices.

5. The computing platform of claim 4, wherein the trend information comprises projected values of one or more cryptocurrencies or predictive information indicating whether the values will likely increase or decrease over a predetermined period of time.

6. The computing platform of claim 4, wherein the memory stores additional computer-readable instructions that, when executed by the at least one processor, further cause the computing platform to:
request, in real time, the trend information, wherein the request for the trend information is sent multiple times throughout execution of the optimization algorithm; and
receive the real time trend information.

7. The computing platform of claim 6, wherein the requests for trend information are sent at a predetermined interval.

8. The computing platform of claim 6, wherein the request for trend information is sent after the first optimal solution is identified and before the second optimal solution has been identified.

9. The computing platform of claim 6, wherein executing the optimization algorithm further comprises executing the optimization algorithm based on the real time trend information.

10. The computing platform of claim 9, wherein the first optimal solution and the second optimal solution are determined, based at least in part, on the real time trend information.

11. The computing platform of claim 1, wherein the currency profile comprises an indication of one or more currency types of the one or more currencies.

12. The computing platform of claim 11, wherein the one or more currency types comprise one or more of: standard currency, foreign currency, or crypto-currency.

13. The computing platform of claim 1, wherein the memory stores additional computer-readable instructions that, when executed by the at least one processor, further cause the computing platform to:
receive, from the user device, an indication that the optimization algorithm should be re-executed and information identifying one or more user profile modifications; and
re-execute, based on the information identifying the one or more user profile modifications, the optimization algorithm to identify a third optimal solution.

14. The computing platform of claim 13, wherein the information identifying the one or more user profile modifications indicates that a particular currency type of the one or more currencies should not be used as an input to the optimization algorithm.

15. The computing platform of claim 1, wherein executing the optimization algorithm comprises executing a simulated annealing algorithm.

16. A method comprising:
at a computing platform comprising at least one processor, a communication interface, and memory:
receiving, from a user device, an event processing request and a user identifier corresponding to the event processing request;
determining a currency profile corresponding to the user identifier and exchange rates for one or more currencies included in the currency profile;
executing an optimization algorithm based on the currency profile and the exchange rates, wherein executing the optimization algorithm comprises:
identifying a first optimal solution for processing the event processing request using at least a first amount of a first currency of the one or more currencies and a second amount of a second currency of the one or more currencies;
identifying a second optimal solution for processing the event processing request using at least a third amount of the first currency of the one or more currencies and a fourth amount the second currency of the one or more currencies;
identifying, by comparing the first optimal solution and the second optimal solution, that the first optimal solution is more effective than the second optimal solution;
generating, based on the first optimal solution, a user interface indicating the first amount of the first currency of the one or more currencies and the second amount of the second currency of the one or more currencies, wherein the user interface presents an option to fulfill the event processing request using the first optimal solution and an option to re-execute the optimization algorithm to determine a different optimal solution; and
sending, to the user device, the user interface, along with one or more commands directing the user device to cause display of the user interface.

17. The method of claim 16, further comprising:
identifying, based on the currency profile, one or more additional parameters for input into the optimization algorithm;
requesting, in response to identifying the one or more additional parameters, an indication of the one or more additional parameters from a currency parameter data source system; and
receiving, in response to the request for the indication of the one or more additional parameters, the one or more additional parameters.

18. The method of claim 17, wherein executing the optimization algorithm further comprises executing, based on the one or more additional parameters, the optimization algorithm.

19. The method of claim 17, wherein the one or more additional parameters comprise one or more of: an exchange rate, a foreign transaction charge, a transaction speed, mining charges, trend information, or gas prices.

20. One or more non-transitory computer-readable media storing instructions that, when executed by a computing platform comprising at least one processor, a communication interface, and memory, cause the computing platform to:
receive, from a user device, an event processing request and a user identifier corresponding to the event processing request;
determine a currency profile corresponding to the user identifier and exchange rates for one or more currencies included in the currency profile;
execute an optimization algorithm based on the currency profile and the exchange rates, wherein executing the optimization algorithm comprises:
identifying a first optimal solution for processing the event processing request using at least a first amount of a first currency of the one or more currencies and a second amount of a second currency of the one or more currencies;
identifying a second optimal solution for processing the event processing request using at least a third amount of the first currency of the one or more currencies and a fourth amount the second currency of the one or more currencies;
identifying, by comparing the first optimal solution and the second optimal solution, that the first optimal solution is more effective than the second optimal solution;
generate, based on the first optimal solution, a user interface indicating the first amount of the first currency of the one or more currencies and the second amount of the second currency of the one or more currencies, wherein the user interface presents an option to fulfill the event processing request using the first optimal solution and an option to re-execute the optimization algorithm to determine a different optimal solution; and
send, to the user device, the user interface, along with one or more commands directing the user device to cause display of the user interface.
